(19) United States
(12) Patent Application Publication
(10) Pub. No.: US 2002/0186619 A1
(43) Pub. Date: Dec. 12, 2002

(54) Apparatus, system and method for synchronizing a clock with a master time service

(76) Inventors: Michael H. Reeves, Athens, GA (US); Thomas G. Guyett, Gainesville, GA (US); Christopher W. Harden, Griffin, GA (US)

Correspondence Address: SONNENSCHEIN NATH & ROSENTHAL, P.O. BOX 061080, WACKER DRIVE STATION- SEARS TOWER, CHICAGO, IL, 60606-1080, US

(21) Appl. No.: 09/850,321

(22) Filed: May 7, 2001

(51) Int. Cl. G04C 11/02

(52) U.S. Cl. 368/47

(57) ABSTRACT

A clock is provided for synchronizing with a master time service. The clock includes a microprocessor configured to obtain time code data from the master time service, process the time code data, and initiate a time keeping function. The clock further includes a time indicator connected to the microprocessor. The time indicator displays a time corresponding to the time code data.

### FIELD OF THE INVENTION

The present invention relates to clocks, and more particularly to an apparatus, system and method for synchronizing a clock with a master time service, such as an Internet time service.

### BACKGROUND OF THE INVENTION

Today, a greater and greater premium has been placed on punctuality. Most activities start at specified times and being late to an activity may result in personal embarrassment or even disciplinary action. In addition, because of the increasing amount of business travel, including international travel, determining the correct time at a particular location has become more difficult.

One prior solution to the problem of obtaining the correct time was the use of radio clocks which included an RF receiver for receiving and decoding a time signal transmitted by a universal time service, such as the National Institute of Standards and Technology (NIST) near Ft. Collins, Colo., USA. NIST broadcasts a Universal Time Coordinated (UTC) signal at 60 KHz. Radio clocks can receive and process the UTC signal to obtain and display the correct time.

NIST radio station WWVB broadcasts the UTC signal. This signal is used to synchronize consumer electronic products, like wall clocks, clock radios, and wristwatches. WWVB continuously broadcasts time and frequency signals at 60 KHz. A time code is synchronized with the 60 KHz carrier frequency and broadcast using pulse width modulation (PWM). The time code contains the year, month, day, hour, minute, second, and flags that indicate the status of Daylight Saving Time, leap years, and leap seconds.

Some radio clocks provide time conversion by means of a switch that can increase or decrease the received time by an appropriate increment (to allow for time zone conversion). Problems with these types of known radio clocks include the fact that UTC signals are calibrated to universal time (a/k/a Greenwich Mean Time). Thus, even radio clocks that allow for manual time zone conversion typically require a time displacement of minus 5-8 hours in order to correct the UTC signal to one of the United States time zones. Such extensive time correction is quite inconvenient. Thus, one problem with known radio clocks is their inability to automatically adjust the universal time to a local time in a different time zone.

Still another problem is that, due to the low strength of the UTC signal, radio clocks inside of steel structures have difficulty receiving the UTC signal.

A further problem is that if the antenna of the radio clock is perpendicular to the UTC signal source, then the clock will have difficulty receiving the UTC signal.

Thus, the radio frequency UTC signal is often difficult to receive. This problem is accentuated in areas where terrain and/or buildings cause RF interference that makes reception of the UTC signal difficult or impossible.

Consequently, there is a need for a system that allows a clock to synchronize itself with a time service without having to depend on an RF signal. There is also a need for a clock that can acquire time code data obtained from a master time service, process the time code data to display a base time, automatically correct the base time to a local time to account for a different time zone, and automatically correct the local time for daylight savings time. The claimed system provides for these and other needs by providing an intelligent clock that can synchronize itself with a master time service that is accessible, for example, through a reliable network such as the Internet.

### SUMMARY OF THE INVENTION

In one embodiment, a clock is provided for synchronizing with a master time service. The clock includes a microprocessor configured to obtain time code data from the master time service, process the time code data, and initiate a time keeping function. The clock further includes a time indicator connected to the microprocessor. The time indicator displays a time corresponding to the time code data.

In a further embodiment, a system is provided for synchronizing a clock with an Internet time service. The system includes a clock having a microprocessor connected to a time indicator. The system further includes a computer connected to the Internet. The computer is configured to download time code data from the Internet time service and to upload the time code data to the microprocessor.

In still another embodiment, a method is provided for synchronizing a clock with a time service via the Internet. The method includes downloading a time code from the time service to a computer via the Internet. The method further includes uploading the time code from the computer to a clock microprocessor. The method also includes processing the time code and displaying a time corresponding to the time code.

### BRIEF DESCRIPTION OF THE DRAWINGS

The organization and manner of operation of the invention, together with further objects and advantages thereof, may best be understood by reference to the following description taken in connection with the accompanying drawings in which like reference numerals identify like elements, and in which:

FIG. 1 is a block diagram of an intelligent clock system according to one embodiment of the present invention;

FIG. 2 is an isometric view of an intelligent clock according to one embodiment of the present invention;

FIG. 3 is an isometric view of the intelligent clock of FIG. 2, taken from a different perspective;

FIG. 4 is an isometric, break-away view of the back of the intelligent clock of FIG. 2, showing some of the components inside of the clock;

FIG. 5 is a front view of a digital display for an intelligent clock according to another embodiment of the present invention;

FIGS. 6a-c are a schematic representation of an intelligent clock according to a further embodiment of the present invention; and

FIG. 7 is a clock display showing how to indicate calendar information on an analog clock according to still another embodiment of the present invention.

### DETAILED DESCRIPTION OF THE INVENTION

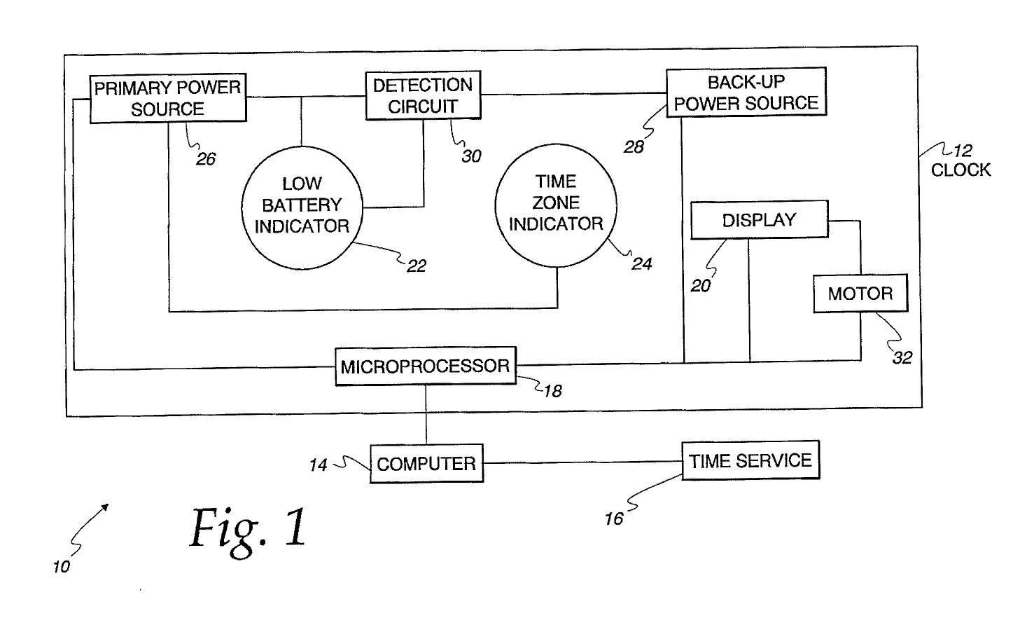

According to one embodiment of the invention, a system 10 for automatically synchronizing a clock with the correct Local time is shown in FIG. 1. The system 10 includes an intelligent clock 12 connected to a computer 14 by, for example, a serial connection, and a master time service 16. The clock 12 is “intelligent” because it is operated by a microprocessor 18. The clock 12 also includes a display 20, a low battery indicator 22, a time zone indicator 24, a primary power source 26, a back-up power source 28, and a detection circuit 30. An analog embodiment of the clock 12 further includes a motor 32 for moving the clock hands to provide an analog display.

In one embodiment, the master time service 16 is an Internet time service that is accessible by the computer 14. The system 10 allows the clock 12 to automatically synchronize itself with the correct time, as provided by an Internet Time Service, such as National Institute of Standards and Technology (NIST). The computer 14 is connected to the Internet. As used herein “connected” means a WAN link, LAN link, Ethernet link, wire link, wireless link, microwave link, satellite link, optical link, cable link, RF link, etc. The time service 16 is also connected to the Internet. In one embodiment, the time service 16 includes a Web server configured to listen for incoming time code requests from Web browsers and respond thereto by sending time code data.

The computer 14, in one embodiment, is running a standard Web browser, such as Microsoft Internet Explorer or Netscape Navigator. The computer 14 sends a request to the time service 16 for a UTC time code. The time service 16 responds to this request by sending the time code to the computer 14 over the Internet (i.e., the time code is downloaded to the computer 14).

It should be noted that the microprocessor 18 need not be directly connected to the computer 14 to receive the time code data. Rather, so long as the time code data from the master time service 16 is acquired by the microprocessor 18, it does not matter how the microprocessor 18 got the time code data. For instance, the user may download the time code data from the NIST Internet Time Service to his/her computer 14. The user may then download the time code data to a Personal Digital Assistant (PDA). The PDA may include a serial link that is connected to the microprocessor 18. The time code data may then be uploaded from the PDA to the microprocessor 18. Similarly, the user may download time code data into a wireless PDA and then synchronize that PDA with the computer 14. The time code data may then be downloaded from the computer 14 to the microprocessor 18 as described herein. Alternatively, there are many other known techniques for obtaining data and transferring data to a microprocessor, all of which are encompassed by the claimed invention.

In another embodiment, the clock 14 includes a modem for accessing the Internet. The microprocessor 18 is connected to the modem and runs a Web browser capable of sending a request to the time service 16 for a UTC time code. The time service 16 responds to this request by sending the time code to the clock 12 over the Internet (i.e., the microprocessor 18 downloads the time code from the Internet).

In a further embodiment, the master time service is the internal clock of the computer 14. A user can manually set the computer's clock to correspond to the correct time as indicated by a reliable source, such as a cable station, a radio station, the BBC (which provides a short wave time signal indicating Greenwich Mean Time), NIST (which broadcasts a UTC radio signal), etc. The user can then upload the time indicated by the computer's clock to the microprocessor 18 via an appropriate interface, such as a serial port, a USB port, etc.

Time code data generally includes the current time and date (day, month, year). In one embodiment, the time code data is obtained from the NIST Web site, which can currently be found at: http://www.boulder.nist.gov/timefreq/service/its.htm. The computer 14 converts the time code data into a format appropriate for uploading to the microprocessor 18 (e.g., a serial interface format). The computer 14 then uploads the converted time code data to the clock microprocessor 18 via an interface, such as a serial port, a USB port, etc. The intelligent clock 12 processes the time code data and displays the correct Local time, as detailed below.

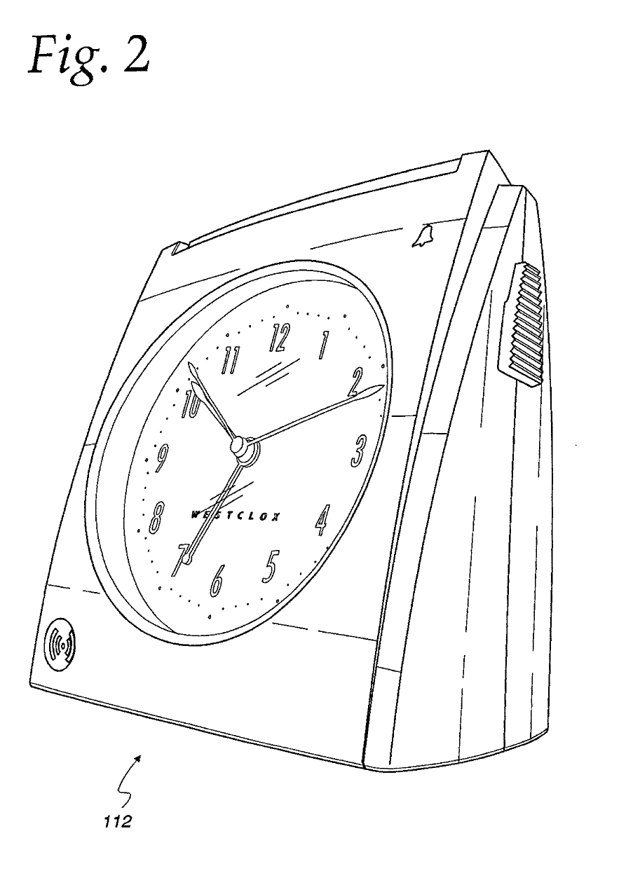

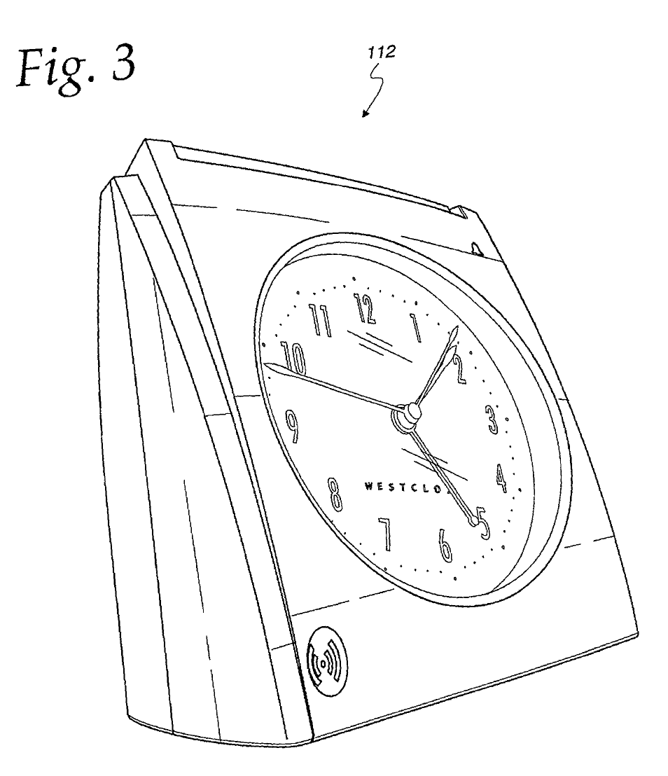

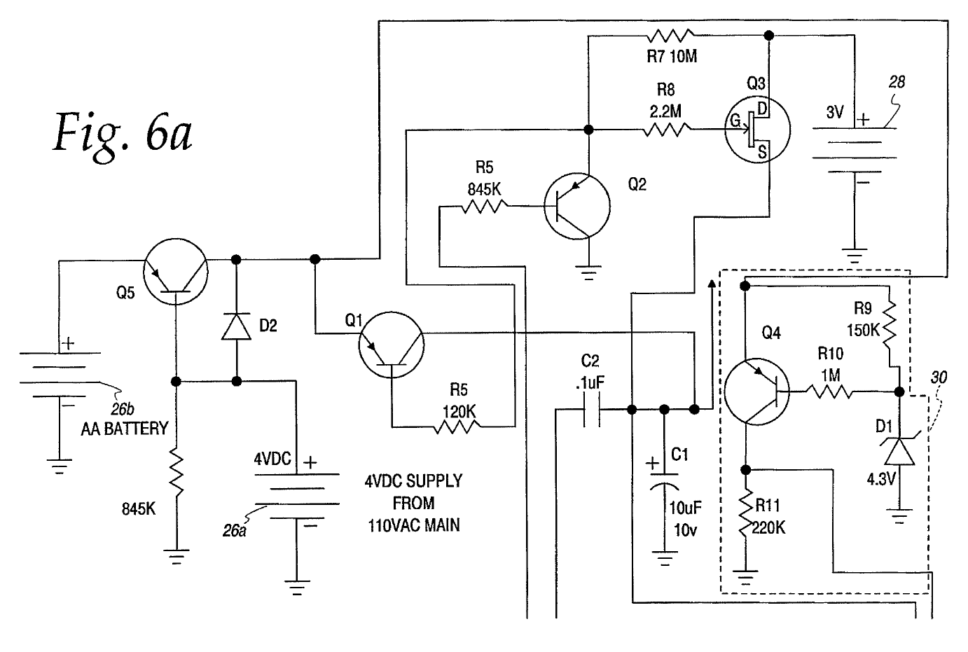

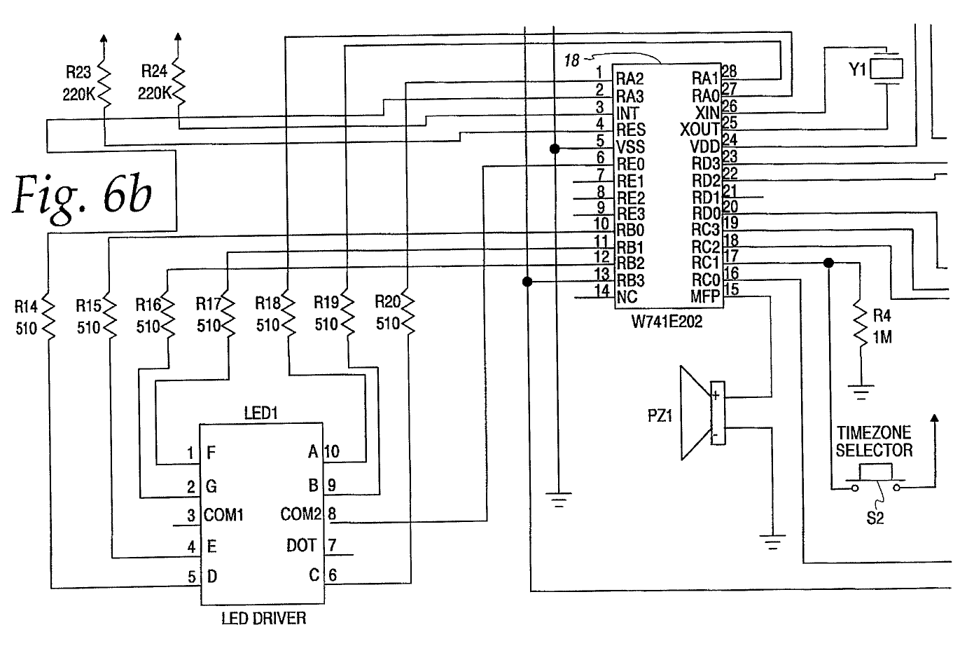

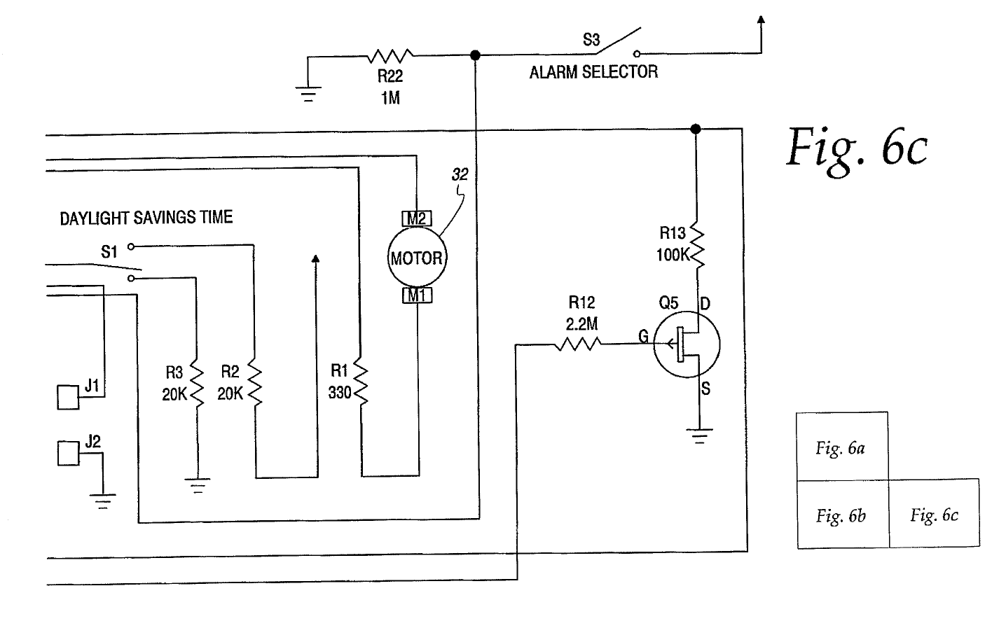

FIG. 2 shows an intelligent clock 112, according to one embodiment of the invention, that provides an analog display produced by quartz movement. The microprocessor 18 replaces the customary integrated circuit (IC) used in prior quartz alarm clocks. The microprocessor 18 is connected to a crystal Y1 (shown in FIG. 6b) to control the movement of the clock 112. FIG. 3 depicts the intelligent clock 112 from another perspective.

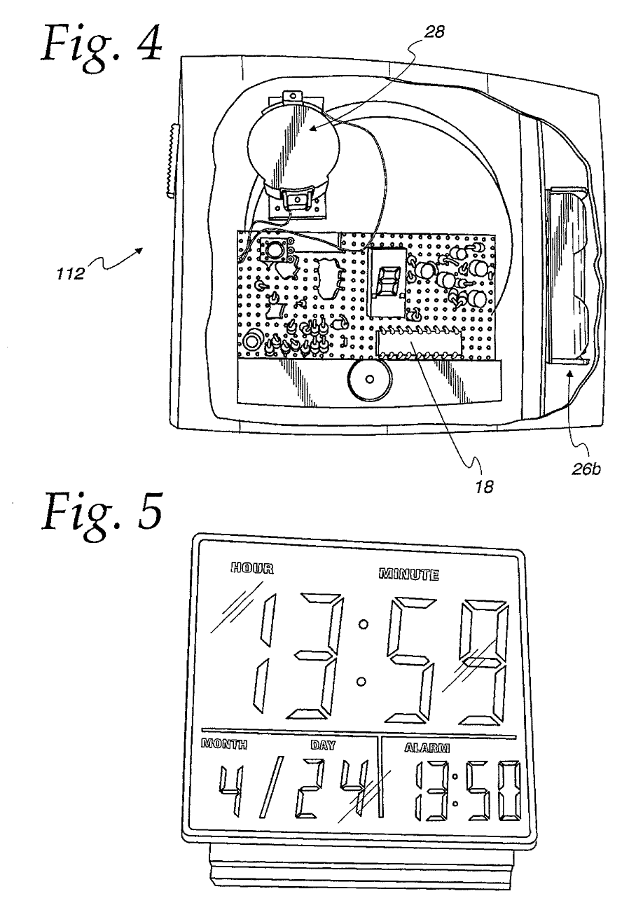

FIG. 4 shows a break-away view of the back of the intelligent clock 112. This view illustrates some of the internal components of the clock 112, including the microprocessor 18, the primary power source 26b, the back-up power source 28, and other assorted electronic components. The microprocessor 18 is connected (either directly or indirectly) to the master time service 16 via an interface, such as a serial port, a USB port, etc.

FIG. 5 shows an LCD display for use with another embodiment of the intelligent clock 12. This display can be used to provide an LCD display for the clock 12. The microprocessor 18 replaces the standard LCD processor and display driver used in prior LCD clocks.

According to a further embodiment of the invention, the intelligent clock 12 provides an LED display. The microprocessor 18 replaces the standard clock chip used in prior LED clocks (e.g., LM8560/62).

FIGS. 6a-c show a schematic for one embodiment of the intelligent clock 12. The illustrated embodiment shows microprocessor 18, two primary power sources 26 (an ac-power source 26a and a DC power source 26b), back-up power source 28, a detection circuit 30, a motor 32, a daylight savings time selection device S1, a time zone selection device S2, a crystal Y1, an LED driver LED 1, and other electronic components known in the art. The microprocessor 18 interfaces with the computer 14 via inputs J1 and J2. Input J1 is connected to pin 19 of the microprocessor 18 and input J2 is connected to ground. An interface, such as a serial port, a USB port, etc., is connected to inputs J1 and J2 to connect the computer 14 with the microprocessor 18.

Referring to FIGS. 1 and 6a-c, the clock 12 comprises primary power source 26, which may include a primary a-c power source 26a and/or a primary battery power source 26b. The primary power source 26 is used to power the motor 32 (for analog operation) or the display 20 and the LCD/LED driver (for digital operation), the microprocessor 18, and other electronic components, such as one or more of the components shown in FIGS. 6a-c. Connecting the primary power source 26 will activate the motor 32 or the clock display 20 and, if included, any calendar functions (e.g., the day, month and year may be displayed). In one embodiment, the primary battery power source 26b includes two AA batteries that produce 3 volts DC to power the clock 12.

In another embodiment, the primary power source 26 includes a 110 volt a-c power source 26a and a re-chargeable primary battery 26b. The a-c voltage may be supplied, for example, via a transformer supplying 110 volts a-c. Alternatively, the a-c voltage may be supplied via a transformer-less system, as described in application Ser. No. 09/451,492, which is assigned to the assignee of the present application and incorporated herein by reference in its entirety. This transformer-less system provides 110 volts at 60 Hz (or 220 volts at 50 Hz).

The clock 12 also includes back-up power source 28 (e.g., a 3 volt back-up battery) for powering the microprocessor 18. The back-up power source 28 provides power to the microprocessor 18 until the primary power source 26 is connected.

Referring to FIGS. 6a-c, the microprocessor 18 monitors the detection circuit 30 on pin 16. The detection circuit 30 detects when the primary power source 26 is connected. When the primary power source 26 is connected, the detection circuit 30 disconnects the back-up power source 28. In the event that the primary power source 26 is thereafter interrupted, the detection circuit 30 will reconnect the back-up power source 28 to continue powering the microprocessor 18. When the detection circuit 30 detects that the primary a-c power source 26a is interrupted, it connects the primary battery 26b to power the clock 12. If the primary battery power is interrupted, the detection circuit 30 connects the back-up battery 28 to continue powering the microprocessor 18 (so it can maintain the correct time).

In one embodiment, the clock 12 includes a low-battery indicator 22, as shown in FIG. 1. The indicator 22 indicates when the user must change the back-up battery 28, and if a primary battery 26 is used, when the user must change the primary battery 26. For example, the microprocessor 18 could cause the indicator 22 to flash once every 10 seconds to indicate that the back-up battery 28 must be changed and twice every 10 seconds to indicate that the primary battery 26b must be changed. Alternatively, the time zone indicator 24 could provide the low-battery indicator function in place of a separate low-battery indicator.

In one embodiment, the time code data is downloaded via the Internet from the time service 16 to the computer 14. The time code typically represents a time referred to herein as the Base time. The Base time is a reference time; the current time in any of the time zones in the world can be selected as the Base time. Usually, a standard time, such as Universal Time Coordinated (a/k/a Greenwich Mean Time) or Eastern Standard Time (EST), is selected as the Base time. The Local time is the current time in the time zone where the clock 12 is currently located. The Base time corresponds to the time code with no adjustment. The Local time typically corresponds to the time code with an adjustment to compensate for a different time zone, DST, etc.

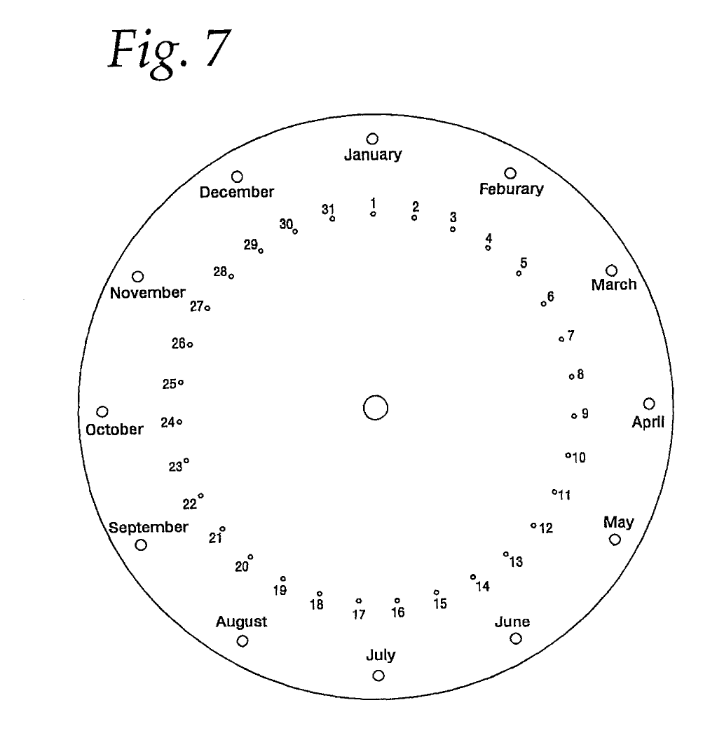

The computer 14 converts the time code data to an output format (e.g., a serial format) and uploads the converted time code data to the clock microprocessor 18 via an interface, such as a serial port, a USB port, etc. Software running on the microprocessor 18 processes the time code data. The microprocessor 18 thereafter maintains the Base time and a perpetual calendar. The microprocessor 18 maintains calendar information, such as the day, date, month and year, in order to automatically adjust the clock 12 for Daylight Savings Time (DST). In one embodiment, some or all of the calendar information is displayed for the user, as shown in FIGS. 5 and 7.

The microprocessor 18, in one embodiment, runs on back-up power supplied by the back-up power source 28 (e.g., a 3 volt battery) while the clock 12 is connected to the computer 14 (to download the time code data from the master time service). The back-up power allows the microprocessor 18 to operate until the clock 12 is connected to the primary power source 26. No time is displayed while the clock 12 is running on back-up power; however, the microprocessor 18 is powered so it can maintain the correct time.

In one embodiment, the manufacturer uploads the time code data to the microprocessor 18 prior to selling the clock 12. Therefore, the microprocessor 18 is configured to obtain the time code data, process the time code data, and initiate a time keeping function (i.e., the microprocessor 18 begins to maintain the correct time). In an alternative embodiment, the user uploads the time code data to the microprocessor 18 after the clock 12 is purchased. Thus, the microprocessor 18 is configured to obtain the time code data, process the time code data, and initiate and/or update a time keeping function. In this way, the user can update the displayed time if, for example, the user has changed time zones.

In one embodiment, the microprocessor 18 comprises an ASIC, FPGA, or other similar chip that is programmed for a specific clock, e.g., an analog clock. In another embodiment, the microprocessor 18 comprises a microcontroller, with either an internal or external memory. On such microcontroller is the W741E202 (shown in FIG. 6b), produced by Winbond Electronics Corporation America, which is a 4-bit microcontroller that provides an internal flash memory (EEPROM). In the microcontroller embodiment, the microprocessor 18 is programmed by downloading (true?) software from the memory to the microcontroller. In either embodiment, once the time code data is first uploaded to the microprocessor 18, a program is run to initiate a time keeping function and thereafter maintain the Base time.

As shown in FIG. 1, the clock 12, in one embodiment, includes a time zone indicator 24. To select the appropriate Local time zone, the user actuates a time zone selection device S2, such as a switch or button, to cycle through a selection of different time zones. In the LED and LCD clock embodiments, a single seven-segment display may be used to select the Local time zone. Such a display can represent the digits 0 through 9. For purposes of example, each digit can correspond to a time zone as follows:

| | |
|---|---|
| 0- UTC - 0 | (UK time) |
| 1- UTC - 4 | (New Brunswick time) |
| 2- UTC - 5 | (US Eastern time) |
| 3- UTC - 6 | (US Central time) |
| 4- UTC - 7 | (US Mountain time) |
| 5- UTC - 8 | (US Pacific time) |
| 6- UTC - 9 | (Alaska time) |
| 7- UTC - 10 | (Hawaii time) |

Generally, the user first connects the primary power source 26 to the clock 12. The detection circuit 30 then switches from the back-up power source 28 to primary power source 26. Next, the user selects the appropriate time zone. The microprocessor 18 then adjusts the Base time uploaded to the microprocessor 18 to the correct Local time. The microprocessor software uses the time zone setting to adjust the Base time to the correct Local time. The microprocessor 18 first converts the Base time to the correct Local time and then compares the displayed time to the correct Local time. In the analog clock embodiment, the microprocessor 18 pulses the quartz movement forward at a measured, accelerated rate until the correct Local time is displayed (i.e., the microprocessor 18 continues to pulse the quartz movement forward until there is no difference between the displayed Local time and the correct Local time). In the LED and LCD clock embodiments, the microprocessor 18 changes the displayed time to the correct Local time (e.g., the microprocessor 18 changes the displayed time (11 am EST) to the correct Local time (10 am CST)).

The microprocessor software, in combination with the calendar information, will automatically adjust the Base time by one hour twice each year to compensate for Daylight Savings Time (DST). There fore, the user will not have to manually adjust the clock 12 to account for DST. When the DST selection device S1 is set to the ON position, the calendar will indicate when DST is in effect. Therefore, when the primary power source 26 is connected, the calendar indicates whether DST is currently in effect. In the analog clock embodiment, the microprocessor 18 will then pulse the clock movement forward one hour (Spring Forward) to adjust the Base time for DST. The calendar will also indicate when DST is over (i.e., when Standard Time is in effect). When Standard Time goes into effect, the microprocessor 18 will pulse the clock movement forward 11 hours (Fall Back) to adjust the Base time for Standard Time. In the LED and LCD clock embodiments, the microprocessor 18 changes the displayed time to account for DST time (e.g., the microprocessor 18 adjusts for DST by changing the displayed time (2 am EST) to the correct Local time (3 am EDT)).

If the time zone indicator is set to UK time (or one of the other countries), the software will also correct for DST in those countries. If where the clock is located DST is not observed (e.g., Arizona, Indiana), the user can set the DST selection device S1 to the Off position. This disables the calendar from indicating when DST is in effect.

In the analog clock embodiment, the clock 112 (shown in FIGS. 2-3) includes a calendar function, wherein the motor 32 is connected to a quartz clock gear train. The motor 32 is also connected to and controlled by the microprocessor 18. The microprocessor 18 pulses the gear train to cause the second, minute and/or hour hands to, for example, indicate the date, and/or month, as shown in FIG. 7.

In another embodiment, the LED clock and the LCD clock include a calendar function, wherein the day, date, month and/or year are displayed via back-lit cutouts corresponding to the day, date, month and/or year. Alternatively, a seven-segment display, such as the one shown in FIG. 5, can display the day, date, month and/or year. The calendar data may be displayed continuously or only when the user actives a selection device.

In a further embodiment, the clock 12 also includes a special event indicator that allows the user to program the clock 12 to remember important days, such as birthdays, anniversaries, etc. A selection device, such as a button or switch, allows the user to scroll from January 1 to December 31 and stop at important dates. The selection device allows the user to select certain dates as special events. On the selected days, the clock 12 can be programmed to play a message or song appropriate for the event (e.g., “Happy Birthday”).

The master time service 16, in one embodiment of the invention, is the National Institute of Science and Technology (NIST). NIST provides time code data via the Internet. Time code data can be downloaded from the NIST Web site, which can currently be found at: http://www.boulder.nist.gov/timefreq/service/its.htm. The system 10 uses the NIST Internet Time Service to synchronize the computer 14 with the NIST universal clock. By uploading the UTC time code from the computer 14 to the clock microprocessor 18, problems with reception inherent in existing radio clocks are eliminated. Moreover, the claimed intelligent clock 12 is less expensive to produce than existing radio clocks.

The NIST Web site provides computer software for maintaining the UTC time on a standard personal computer, such as the computer 14. The NIST Internet Time Service (ITS) allows a user to synchronize the clock of computer 14 with the UTC time via the Internet. The ITS responds to time requests from any Internet client (e.g., a Web browser) in several formats. The UTC time code formats are defined by several Requests for Comments (RFCs). The time code protocols supported by the NIST Internet Time Service include: the Daytime Protocol (RFC-867), the Time Protocol (RFC-868), and the Network Time Protocol (NTP) (RFC-1305).

Daytime Protocol (RFC-867) is widely used by computers running MS-DOS and similar operating systems. The NIST server listens for time requests and responds thereto via TCP/IP or UDP/IP. The Daytime Protocol sends the current time using standard ASCII characters. The NIST time code format is similar to the one used by its dial-up Automated Computer Time Service (ACTS), as shown below:

JJJJJ YR-MO-DA HH:MM:SS TT L H msAD V UTC(NIST) OTM

where:

JJJJJ is the Modified Julian Date (MJD). The MJD is the last five digits of the Julian Date, which is simply a count of the number of days since Jan. 1, 4713 B.C. To calculate the Julian Date, add 2.4 million to the MJD.

YR-MO-DA is the date. It shows the last two digits of the year, the month, and the current day of month.

HH:MM:SS is the time in hours, minutes, and seconds. The time is always sent as Universal Time Coordinated (UTC). An offset needs to be applied to UTC to obtain Local time. For example, Mountain Time in the U.S. is seven hours behind the UTC time during Standard Time, and six hours behind the UTC time during Daylight Saving Time (DST).

TT is a two digit code (00 to 99) that indicates whether the United States is on Standard Time (ST) or Daylight Saving Time (DST). It also indicates when ST or DST is approaching. This code is set to 00 when ST is in effect, or to 50 when DST is in effect. During the month in which the time change actually occurs, this number will decrement every day until the change occurs. For example, during the month of October, the U.S. changes from DST to ST. On October 1, the number will change from 50 to the actual number of days until the time change. It will decrement by 1 every day until the change occurs at 2 a.m. local time when the value is 1. Likewise, the spring change is at 2 a.m. local time when the value reaches 51.

L is a one-digit code that indicates whether a leap second will be added or subtracted at midnight on the last day of the current month. If the code is 0, no leap second will occur this month. If the code is 1, a positive leap second will be added at the end of the month. This means that the last minute of the month will contain 61 seconds instead of 60. If the code is 2, a second will be deleted on the last day of the month. Leap seconds occur at a rate of about one per year. They are used to correct for irregularity in the earth's rotation. The correction is made just before midnight UTC.

H is a health digit that indicates the health of the NIST server. If H=0, the server is healthy. If H=1, then the server is operating properly but its time may be in error by up to 5 seconds. This state should change to fully healthy within 10 minutes. If H=2, then the server is operating properly but its time is known to be wrong by more than 5 seconds. If H=4, then a hardware or software failure has occurred and the amount of the time error is unknown.

msADV displays the number of milliseconds that NIST advances the time code to partially compensate for network delays. The advance is currently set to 50.0 milliseconds.

The label UTC(NIST) is contained in every time code. This label indicates that the user is receiving Universal Time Coordinated (UTC) from the National Institute of Standards and Technology (NIST).

OTM (on-time marker) is an asterisk (*). The time values sent by the time code refer to the arrival time of the OTM. In other words, if the time code says it is 12:45:45, this means it is 12:45:45 when the OTM arrives.

RFC-868 defines the Time Protocol, which returns a 32-bit unformatted binary number that represents the time in UTC seconds since Jan. 1, 1900. The NIST server listens for Time Protocol requests on port 37, and responds in either TCP/IP format or UDP/IP format. Conversion to Local time (if necessary) is the responsibility of the client program. The 32-bit binary format can represent times over a span of about 136 years with a resolution of one second. There is no provision for increasing the resolution or increasing the range of years.

The Network Time Protocol (NTP) (RFC-1305) is the most complex and sophisticated of the Internet UTC time code protocols, and the one that provides the best performance. The NIST server listens for a NTP request on port 123, and responds by sending a UDP/IP data packet in the NTP format. The data packet includes a 64-bit timestamp containing the time in UTC seconds since Jan. 1, 1900 with a resolution of 200 picoseconds. Since the client software runs continuously, it can keep the client's clock within a few milliseconds of UTC(NIST).

The system of the claimed invention can operate using any of the above time code formats. Likewise, any suitable time service, using any known time code format, could be used with the claimed system.

The present invention thus provides a system for allowing an intelligent clock to synchronize itself with a master time service, such as an Internet time service. This claimed design eliminates the reception problems associated with prior art radio clocks that depend on RF signals. In one embodiment, the claimed clock also adjusts the Base time to the Local time where the clock is currently located (i.e., the clock automatically adjusts the Base time to the correct Local time in the selected time zone). The clock also provides an optional calendar function that allows the clock to automatically correct the current Local time for daylight savings time.

While particular embodiments of the invention have been shown and described in detail, it will be obvious to those skilled in the art that changes and modifications of the present invention, in its various embodiments, may be made without departing from the spirit and scope of the invention because these modifications and changes would be matters of routine engineering or design. As such, the scope of the invention should not be limited by the particular embodiments and specific constructions described herein but should be defined by the appended claims and equivalents thereof.

What is claimed is:

1. A clock for synchronizing with a master time service, the clock comprising:
a microprocessor configured to obtain time code data from the master time service, process the time code data, and initiate a time keeping function; and
a time indicator connected to the microprocessor, the time indicator displaying a time corresponding to the time code data.

2. The clock of claim 1, wherein the master time service is an Internet time service.

3. The clock of claim 1, wherein the master time service is an internal clock in a computer.

4. The clock of claim 1, wherein the microprocessor acquires the time code data via a serial connection.

5. The clock of claim 1, wherein the microprocessor acquires the time code data via a USB port.

6. The clock of claim 1, wherein the time code data conforms to a protocol selected from the group consisting of the Daytime Protocol (RFC-867), the Time Protocol (RFC-868), and the Network Time Protocol (RFC-1305).

7. The clock of claim 1, wherein the time code data represents a base time, the microprocessor converting the base time to a local time.

8. The clock of claim 1, further including a time zone indicator.

9. The clock of claim 1, further including a selection device for selecting a time zone.

10. The clock of claim 1, wherein the time code data represents a base time, the microprocessor converting the base time to a local time.

11. The clock of claim 1, further including a selection device for selecting a daylight savings time mode.

12. The clock of claim 1, wherein the time code data represents a base time, the microprocessor automatically adjusting the base time to account for daylight savings time.

13. The clock of claim 1, further including providing an analog display.

14. The clock of claim 1, further including providing an liquid crystal display (LCD).

15. The clock of claim 1, further including providing a light emitting diode (LED) display.

16. A clock for synchronizing with an Internet time service accessible by a computer, the clock comprising:
a microprocessor configured to download time code data from the computer and process the time code data; and
a time indicator connected to the microprocessor, the time indicator displaying a time corresponding to the time code data.

17. The clock of claim 16, wherein the microprocessor acquires the time code data from the computer via a serial connection.

18. The clock of claim 16, wherein the microprocessor acquires the time code data from the computer via a USB port.

19. The clock of claim 16, wherein the time code data represents a base time, the microprocessor converting the base time to a local time.

20. The clock of claim 16, wherein the clock includes a low-power indicator.

21. The clock of claim 16, further including a back-up power source.

22. The clock of claim 16, further including a primary power source.

23. The clock of claim 22, wherein the primary power source is a battery.

24. The clock of claim 22, wherein the primary power source is an a-c power source.

25. The clock of claim 22, wherein the microprocessor detects when the primary power source is interrupted.

26. The clock of claim 25, wherein a back-up power source is connected to power one or more components of the clock.

27. The clock of claim 16, further including a time zone indicator.

28. The clock of claim 16, further including a selection device for selecting a time zone.

29. The clock of claim 28, wherein the time code data represents a base time, the microprocessor using the selected time zone to adjust the base time to a local time.

30. The clock of claim 16, wherein the time code data represents a base time, the microprocessor converting the base time to a local time.

31. The clock of claim 30, wherein the microprocessor compares the base time to the local time.

32. The clock of claim 31, wherein the microprocessor displays the base time and adjusts the base time until there is no difference between the displayed time and the local time.

33. The clock of claim 16, wherein the clock includes a special event indicator.

34. The clock of claim 16, further including a selection device for selecting a daylight savings time mode.

35. The clock of claim 16, wherein the time code data represents a base time, the microprocessor automatically adjusting the base time to account for daylight savings time.

36. The clock of claim 16, wherein the microprocessor includes a calendar function.

37. The clock of claim 16, wherein the Internet time service is accessible by the computer via a wireless link.

38. The clock of claim 16, wherein the Internet time service is accessible by the computer via a wire link.

39. The clock of claim 16, further including providing an analog display.

40. The clock of claim 16, further including providing an liquid crystal display (LCD).

41. The clock of claim 16, further including providing a light emitting diode (LED) display.

42. A method of synchronizing a clock with a time service via the Internet, the method comprising:
downloading a time code from the time service to a computer via the Internet;
uploading the time code from the computer to a microprocessor in the clock; and
processing the time code.

43. The method of claim 42, wherein the time code represents a base time, further including converting the base time to a local time.

44. The method of claim 43, further including displaying the local time.

45. The method of claim 42, further including providing a back-up power source.

46. The method of claim 42, further including providing a primary power source.

47. The method of claim 46, wherein the primary power source is a battery.

48. The method of claim 47, further including indicating when the battery is low.

49. The method of claim 46, further including detecting when the primary power source is interrupted.

50. The method of claim 49, further including connecting a back-up power source to power one or more components of the clock.

51. The method of claim 42, further including providing a time zone indicator.

52. The method of claim 42, further including selecting a time zone via a selection device.

53. The method of claim 52, wherein the time code represents a base time, further including using the time zone selection to adjust the base time to a local time.

54. The method of claim 42, wherein the time code represents a base time, further including adjusting the base time to a local time.

55. The method of claim 42, wherein the time code represents a local time, further including automatically correcting the local time to account for daylight savings time.

56. The method of claim 42, further including providing a time zone indicator.

57. The method of claim 42, further including providing a low-power indicator.

58. The method of claim 42, wherein the time code is uploaded to the microprocessor via a serial connection.

59. The method of claim 42, wherein the time code represents a base time, further including displaying the base time and comparing the base time to the local time.

60. The method of claim 59, further including adjusting the displayed time until there is no difference between the displayed time and the local time.

61. The method of claim 42, further including a special event indicator.

62. The method of claim 42, further including a selection device that allows a user to indicate a certain date.

63. The method of claim 62, further including playing a message on the certain date.

64. The method of claim 42, further including providing an analog display.

65. The method of claim 42, further including providing an liquid crystal display (LCD).

66. The method of claim 42, further including providing a light emitting diode (LED) display.

67. The method of claim 42, further including displaying calendar information.

68. A clock that synchronizes with a time service, the clock comprising:
a microprocessor configured to acquire time code data from an Internet time service; and
a time indicator connected to the microprocessor, the time indicator displaying a time provided by the microprocessor.

69. The clock of claim 68, wherein the clock includes a wireless connection to the Internet time service.

70. The clock of claim 68, wherein the clock includes a serial connection to the Internet time service.

71. The clock of claim 68, wherein the clock includes a serial connection to a computer connected to the Internet time service.

72. The clock of claim 68, wherein the time code data represents a base time, the microprocessor adjusting the base time to a local time.

73. The clock of claim 72, wherein the microprocessor displays the local time.

74. The clock of claim 72, wherein the microprocessor corrects the local time to account for daylight savings time.

75. A system for synchronizing a clock with an Internet time service, the system comprising:
a clock including a microprocessor connected to a time indicator; and
a computer connected to the Internet; the computer being configured to download time code data from the Internet time service and to upload the time code data to the microprocessor.

76. The system of claim 75, wherein the microprocessor processes the time code data.

77. The system of claim 75, wherein the clock further includes a time zone selection device.

78. The system of claim 75, wherein the time code data represents a base time corresponding to a first time zone.

79. The system of claim 78, wherein the base time is adjusted to a local time corresponding to a second time zone.

80. The system of claim 79, wherein the microprocessor adjusts the local time to account for daylight savings time.
